(19) United States
(12) Patent Application Publication
(10) Pub. No.: US 2012/0109715 A1
(43) Pub. Date: May 3, 2012

(54) VISUALIZING VISITATION PATTERNS AT SITES OF A COMMERCIAL FACILITY

(76) Inventors: Peng Wu, San Jose, CA (US); Hui Chao, San Jose, CA (US); Daniel R. Tretter, San Jose, CA (US)

(21) Appl. No.: 12/916,310

(22) Filed: Oct. 29, 2010

(51) Int. Cl. G06Q 10/00

(52) U.S. Cl. 705/7.33

(57) ABSTRACT

Sensor data characterizing detected physical presence characteristics of customers visiting respective sites distributed about a commercial facility is obtained. Visitation patterns of different demographic groups of the customers to the sites are determined. A graphic visualization of one or more of the visitation patterns is generated.

### BACKGROUND

Many systems have been developed for identifying patterns in customer behaviors in order to increase revenue, improve efficiency, and reduce costs of various aspects of their respective businesses. For example, loyalty card programs enable companies to identify customer purchasing patterns across different demographic groups, which information can be used to improve the effectiveness of marketing campaigns. Other systems have been proposed for grouping the customers visiting a retail establishment by profitability based on camera and other sensor based data captured at a retail facility, and for focusing marketing incentive initiatives at the most profitable of the customer groups. Still other systems have been proposed that dynamically match advertisements that are presented on public displays to the detected characteristics of the passing by the displays so that the most relevant advertising is displayed at any given time.

Systems and methods of visualizing customer visitation patterns of customers to sites of a commercial facility are described herein.

### DESCRIPTION OF DRAWINGS

FIG. 1 is a block diagram of an example of a data processing system that generates graphic visualizations of visitation patterns of different demographic groups of customers to sites of a commercial facility.

FIG. 2 is a flow diagram of an example of a method generating graphic visualizations of visitation patterns of different demographic groups of customers to sites of a commercial facility.

FIG. 3 is a block diagram of an example of a data processing system.

FIG. 4 is a diagrammatic view of an example of a data model of a visitation record.

FIG. 5 is a block diagram of an example of a data extraction stage of an example of a data processing system.

FIG. 6 is a diagrammatic view of an example of a graphical user interface showing an example of a graphic visualization of a visitation pattern of a demographic group of customers to a site of a commercial facility.

FIG. 7 is a diagrammatic view of an example of a graphical user interface showing an example of a graphic visualization of a visitation pattern of a demographic group of customers to a site of a commercial facility.

FIG. 8 is a block diagram of an example of a computer system.

### DETAILED DESCRIPTION

In the following description, like reference numbers are used to identify like elements. Furthermore, the drawings are intended to illustrate major features of example embodiments in a diagrammatic manner. The drawings are not intended to depict every feature of actual embodiments nor relative dimensions of the depicted elements, and are not drawn to scale.

A “computer” is any machine, device, or apparatus that processes data according to computer-readable instructions that are stored on a computer-readable medium either temporarily or permanently. A “computer operating system” is a machine readable instructions component of a computer system that manages and coordinates the performance of tasks and the sharing of computing and hardware resources. A “software application” (machine readable instructions, also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” refers to any tangible, non-transitory medium capable storing instructions and data that are readable by a machine (e.g., a computer). Storage devices suitable for tangibly embodying these instructions and data include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “window” is a visual area of a display that typically includes a user interface. A window typically displays the output of a machine readable instructions process and typically enables a user to input commands or data for the machine readable instructions process. A window that has a parent is called a “child window.” A window that has no parent, or whose parent is the desktop window, is called a “top-level window.” A “desktop” is a system-defined window that paints the background of a graphical user interface (GUI) and serves as the base for all windows displayed by all machine readable instructions processes.

A “customer” is any person that visits a commercial facility, regardless of the purchase intentions of that person.

As used herein, the term “includes” means includes but not limited to, the term “including” means including but not limited to. The term “based on” means based at least in part on.

The embodiments that are described herein provide systems and methods of visualizing visitation patterns of customers to sites distributed about a commercial facility. The visitation pattern visualizations that are provided by these embodiments, enable companies to better manage a variety of different processes that are involved in running a commercial facility, including running marketing campaigns in relation to individual ones of the sites (e.g., determining the effectiveness of a particular advertisement or other promotion that is presented at a particular site), optimizing a new or existing site in relation to neighboring sites, managing traffic flows through the commercial facility, and scheduling staffing for respective ones of the sites.

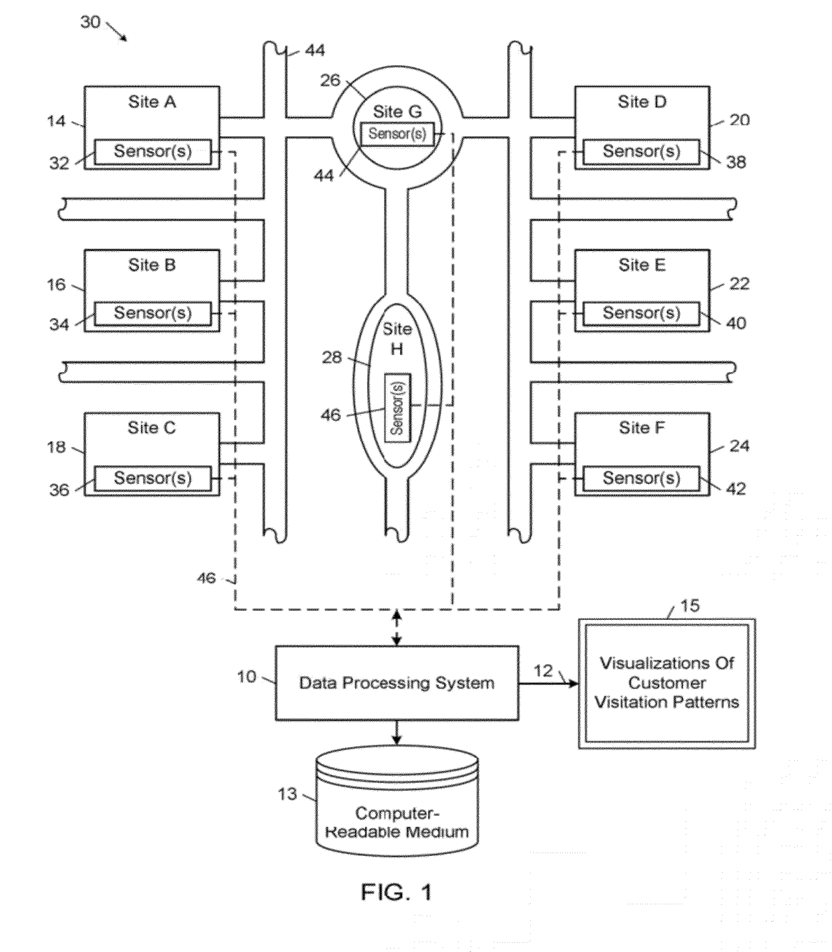

FIG. 1 shows an example of a data processing system 10 that generates graphic visualizations 12 of visitation patterns of different demographic groups of customers to sites 14-28 of a commercial facility 30. The graphic visualizations 12 typically are detected by data structures that are stored on a computer-readable medium 13. The stored visualizations typically are rendered in a graphical user interface on a display 15 for presentation to a user (e.g., a manager of the commercial facility 30).

The commercial facility 30 may be any type of place of business in which commercial points of interest are located at different respective sites distributed about a geographic area. Examples of such commercial facilities include amusement parks (e.g., a Disney® theme park or water park), resorts, shopping malls, educational facilities, and event facilities, such as stadiums, arenas, auditoriums, sports stands, fairgrounds, and ad hoc collections of related commercial points of interest. In the illustrated example, the sites 14-28 are interconnected by designated paths 44 (e.g., sidewalks, aisles, lanes, and bike paths). In other examples, the sites of the commercial facility may be laid out in an open area that is free of any designated walkways or traffic flow influencing routes.

Each of the sites 14-28 of the commercial facility 30 is associated with a respective set 32-36 of one or more sensors that collect environmental data describing conditions and events in the vicinities of the respective sites 14-28. Examples of such sensors include audio sensors (e.g., microphones), visual sensors (e.g., still image cameras and video cameras that capture images of the customers), motion sensors, tag reader sensors (e.g., a radio frequency identification (RFID) tag reader), and other types of detection apparatus. The collected sensor data is transmitted to the data processing system 10 via a data transmission system 46. The data transmission system 46 typically includes a number of different network computing platforms and transport facilities, including a wireless network and a computer network (e.g., the internet), that support a variety of different media formats (e.g., wired and wireless data transmission formats).

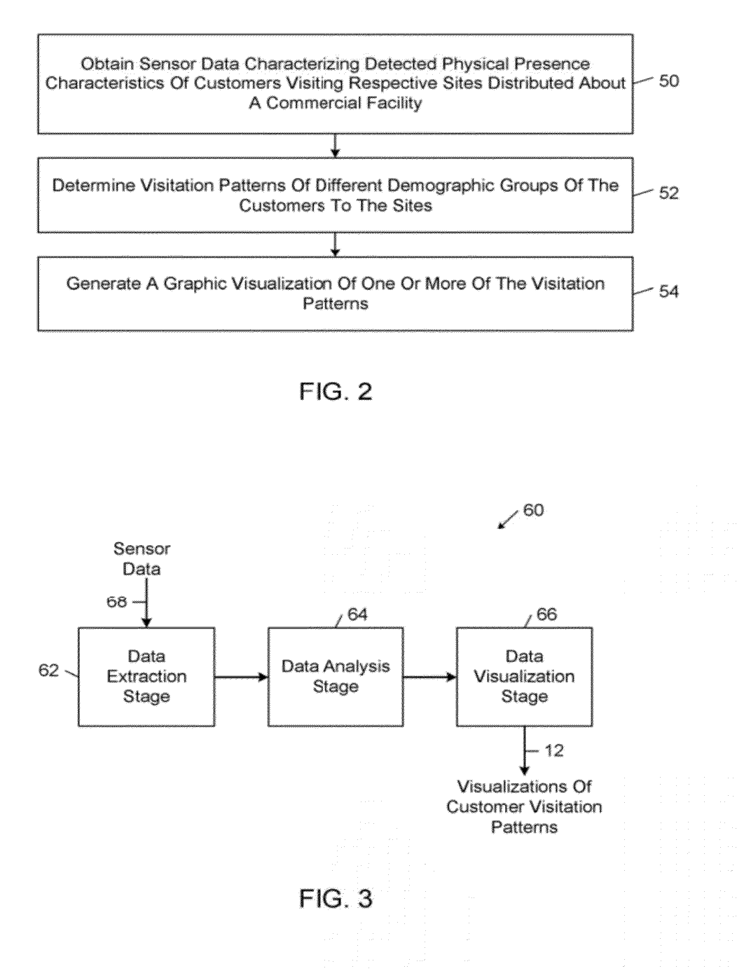

FIG. 2 shows an example of a method by which the data processing system 10 generates the graphic visualizations 12 of visitation patterns of different demographic groups of customers to the sites 14-28 of the commercial facility 30. In accordance with the example of FIG. 2, the data processing system 10 obtains sensor data characterizing detected physical presence characteristics of customers visiting respective sites distributed about a commercial facility (FIG. 2, block 50). The data processing system 10 determines visitation patterns of different demographic groups of the customers to the sites (FIG. 2, block 52). The data processing system 10 generates a graphic visualization of one or more of the visitation patterns (FIG. 2, block 54).

FIG. 3 is a block diagram of an example 60 of the data processing system 10 that includes a data extraction stage 62, a data analysis stage 64, and a data visualization stage 66. A detailed description of each of these stages is provided below.

The data extraction stage 62 processes the sensor data 68 received from the sets 32-36 of sensors associated with the sites 14-28 to produce semantic data. In some examples, the data extraction stage 62 extracts objects and properties or characteristics of the objects from the sensor data 68. The data extraction stage 62 typically associates the extracted data with other data (e.g., metadata that identifies the respective sensors that captured the corresponding sensor data) to achieve a semantic description of customer visits to the associated sites 14-28. In some examples, the data processing system 10 detects faces in image-based sensor data (e.g., still images and video images) and ascertains respective demographic attributes of the detected faces. The data extraction stage 62 typically associates each detected face with a respective person object identifier. For each detected face, the data extraction stage 62 typically classifies the detected face into one or more demographic groups. Examples of such demographic groups include an age group (e.g., baby, child, teenager or youth, adult, senior), a gender group (e.g., male or female), ethnicity (Caucasian, Eastern Asian, African, etc.) and a relationship group (e.g., a family, a couple, or a single person or individual).

The data processing system 10 typically generates a respective visitation record for each of the detected faces. Each visitation record typically includes at least one demographic attribute that is ascertained for the respective detected face, an identification of a corresponding one of the sites associated with the particular image in which the face was detected, and a visitation time corresponding to the time at which the particular image was captured.

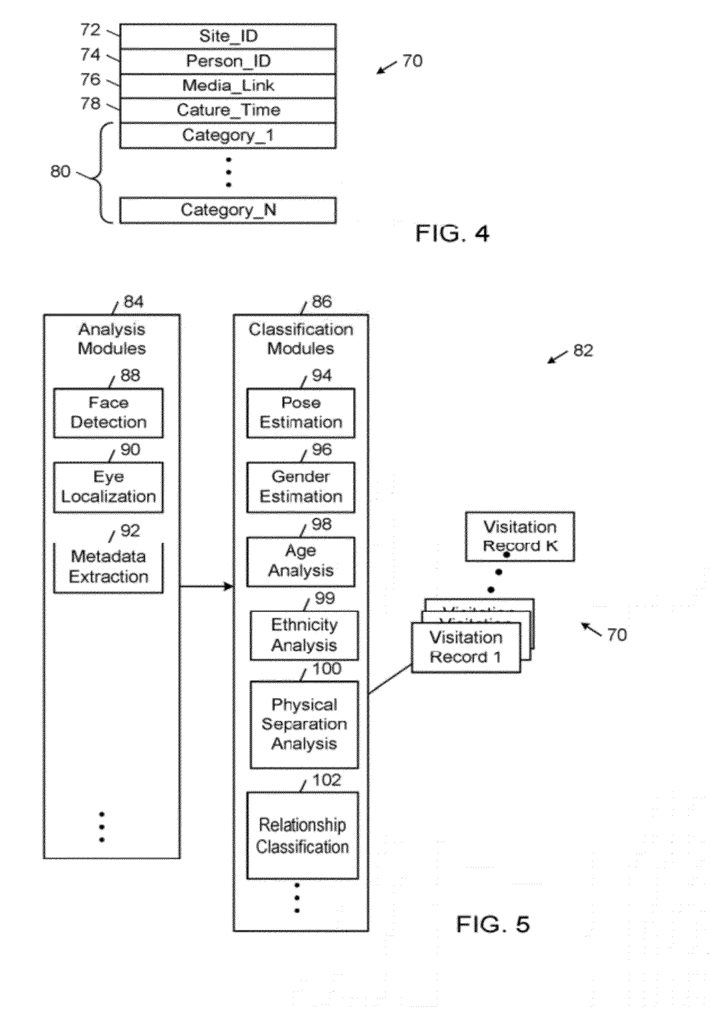

FIG. 4 shows an example of a data model of a visitation record 70. In the illustrated example, the visitation record data model 70 includes a number of data fields, including a Site_ID field 72, a Person_ID field 74, a Media_Link field 76, a Capture_Time field 78, and one or more Category fields 80. The Site_ID field 72 contains an identifier of the respective one of the sites 14-28 from which the corresponding sensor data was collected. The Person_ID field 74 contains a unique identifier that is associated with the respective detected face. The Media_Link field 76 contains a reference (e.g., a uniform resource locator (URL) or hyperlink) to the associated sensor data from which the respective detected face was extracted. The Capture_Time field 78 contains a time value indicating the time at which the corresponding sensor data was captured by the respective sensor. The one or more Category fields 80 contain values indicating the respective groups into which the detected face was classified.

FIG. 5 shows an example 82 of the data extraction stage 62 (FIG. 3) that includes a set 84 of analysis modules and a set of classification modules 86. The set 84 of analysis modules includes a face detection module 88, an eye localization module 90, and a metadata extraction module 92. The set 86 of classification modules includes a pose estimation module 94, a gender estimation module 96, an age analysis module 98, an ethnicity estimation module 99, a physical separation analysis module 100, and a relationship classification module 102. The classification modules 94-102 typically are implemented by pre-built classifiers.

The face detection module 88 provides a preliminary estimate of the location, size, and pose of the faces appearing in the input image 24. A confidence score also may be output for each detected face. In general, the face detection module 88 may use any type of face detection process that determines the presence and location of each face in image based sensor data. Example face detection methods include but are not limited to feature-based face detection methods, template-matching face detection methods, neural-network-based face detection methods, and image-based face detection methods that train machine systems on a collection of labeled face samples. An example feature-based face detection approach is described in Viola and Jones, “Robust Real-Time Object Detection,” Second International Workshop of Statistical and Computation Theories of Vision—Modeling, Learning, Computing, and Sampling, Vancouver, Canada (Jul. 13, 2001). An example neural-network-based face detection method is described in Rowley et al., “Neural Network-Based Face Detection,” IEEE Transactions on Pattern Analysis and Machine Intelligence, Vol. 20, No. 1 (January 1998). In some examples, the face detection module 88 outputs one or more face region parameter values, including the locations of the face areas, the sizes (i.e., the dimensions) of the face areas, and the rough poses (orientations) of the face areas. In some of these examples, the face areas are demarcated by respective rectangle boundaries that define the locations, sizes, and poses of the face areas appearing in the image based sensor data.

The eye localization module 90 provides an estimate of the locations of one or both eyes in a detected face region. The output of this module is a set of eye location pairs, where each pair indicates the locations of two eyes of one person. A confidence score may be output for each pair of detected eye locations, which is derived from the likelihood value in the eye detection process. In general, the eye localization module 90 may use any type of eye localization process that determines the presence and location of each eye in the detected face region. Example eye localization methods include feature-base eye localization methods that locate eyes based on one or more features (e.g., gradients, projections, templates, wavelets, and radial symmetry transform), and feature maps determined from color characteristics of the input image. In some eye localization methods, color cues or eye-pair characteristics are used to improve eye localization and reduce false alarms in the results of a feature-based eye localization method. In one example, the eye localization module 90 determines a skin map of the face region, detects two non-skin areas that are located in the top portion (e.g., top one third) of the face region, and selects the centroids of the two non-skin areas as the locations of the eyes. In some examples, the confidence level of the eye locations depends on the sizes of the detected non-skin areas, where smaller sizes are associated with lower confidence values.

The metadata extraction module 92 extracts metadata (e.g., site identifiers and capture time values) from the sensor data and incorporates the extracted metadata into the corresponding fields of the visitation records 70.

The pose estimation classification module 94 provides an estimate of the pose of the detected face region. In some examples, the pose estimation module 60 identifies out-of-plane rotated faces by detecting faces that are oriented in a profile pose by more than a certain degree, and identifies faces that are tilted up or down more than a certain degree. Any type of the pose estimation method may be used by the pose estimation module 94 to estimate poses of the detected face regions (see, e.g., Murphy-Chutorian, E.; Trivedi, M. M.; “Head Pose Estimation in Computer Vision: A Survey” IEEE Transactions on Pattern Analysis and Machine Intelligence Volume 31, Issue 4, April 2009 Page(s):607-626). In some examples, the pose of the detected face region is determined based on the locations of features (or landmarks) in the detected face region, such as the eyes and the mouth. In examples in which the face areas are demarcated by respective elliptical boundaries, the poses of the face areas are given by the orientations of the major and minor axes of the ellipses, which are usually obtained by locally refining the circular or rectangular face areas originally detected by the face detection module 88.

The gender estimation classification module 96 classifies detected faces into respective gender groups (e.g., male or female). Any type of gender estimation method may be used by the gender estimation module 96 to classify detected faces into different gender categories (see, e.g., Jun-ichiro Hayashi et al., “Age and Gender Estimation Based on Facial Image Analysis,” Knowledge-Based Intelligent Information And Engineering Systems, Lecture Notes in Computer Science, 2003, Volume 2774/2003, 863-869).

The age analysis classification module 98 classifies each detected face into a respective one of a set of age groups (e.g., baby, child, teenager or youth, adult, and senior). Any type of age estimation method may be used by the age estimation module 98 to classify detected faces into different age categories (see, e.g., Xin Geng et al., “Automatic Age Estimation Based on Facial Aging Patterns,” IEEE Transactions on Pattern Analysis and Machine Intelligence, Volume: 29 Issue: 12, pages: 2234-2240 (December 2007). In some examples, features that are most discriminative for the boundary age groups (e.g., babies and seniors) are used first to identify members of these age groups, and then the remaining age groups (e.g., child, teenager or youth, and adult) are identified using a different set of features that are most discriminative of these age groups.

The ethnicity classification module 99 classifies each detected face into a respective one of a set of ethnic groups (e.g., Caucasian, Eastern Asian, and African). Any type of ethnicity estimation method may be used by the ethnicity estimation module 99 to classify detected faces into different ethnic categories (see, e.g., Satoshi Hosoi, et al., “Ethnicity estimation with facial images,” Proceedings of the Sixth IEEE International Conference on Automatic Face and Gesture Recognition, May 2004, pages: 195-200).

The physical separation analysis module 100 determines estimates of physical distances separating individual customers concurrently visiting a respective one of the sites 14-28.

The relationship classification module 102 determines relationships between respective ones of the customers concurrently vising a particular one of the sites, and assigns these customers into respective relationship type demographic groups based on the determined relationships. In some examples, the relationship analysis module 102 designates two or more of the customers concurrently visiting a site as members of a respective relationship unit based on the respective age categories determined for the customers. For example, if the relationship analysis module 102 detects a concurrent site visitation by an adult and a child, the relationship analysis module 102 may assign the detected person objects to a family relationship group. In some examples, the relationship analysis module 102 uses additional information in classifying customers into relationship groups. In these examples, relationship analysis module 102 may use both the determined age categories and the determined gender categories of persons concurrently visiting a site in classifying customers into relationship groups. For example, the relationship analysis module 102 may assign two customers concurrently visiting a particular site into a couple relationship group in response to a determination that that the customers are classified in the same age category (e.g., adults) and are classified in different gender groups (e.g., male and female). In some examples, the relationship analysis module 102 also uses the separation distance information determined by the physical separation analysis module 100 in classifying concurrent visitors into relationship groups, where the closer the visitors are to one another the more likely the relationship analysis module 102 is to classify the visitors into a respective one of the family and couple relationship groups, as opposed to the single relationship group. The relationship classification module 102 may use additional methods in classifying customers into the family relationship group (see, e.g., Tong Zhang et al., “Consumer Image Retrieval by Estimating Relation Tree From Family Photo Collections,” CIVR 2010, Proceedings of the ACM International Conference on Image and Video Retrieval, pages 143-150 (Jul. 5-7, 2010).

The data analysis stage 64 (FIG. 3) uses statistical analysis and data mining techniques to determine one or more statistical summaries of the data contained in the visitation records 70. In some examples, these summaries describe visitation patterns of different demographic groups of the customers to the sites 14-28. In one example, the data analysis stage 64 determines one or more summaries of the traffic of a certain age group visiting a selected one of the sites 14-28 during a particular time frame. In another example, the data analysis stage 64 determines, whether a selected one of the sites 14-28 is most favored by individuals or groups and, if the site was favored by groups, what is the typical age composition for such groups.

The data analysis stage 64 also determines representative members of respective ones of the demographic groups. The data analysis stage 64 typically uses an image clustering technique to determine a respective representative face image for each demographic group along a particular demographic dimension (e.g., age, gender, or relationship). In this process, the face image may be clustered in a wide variety of different ways, including but not limited to k nearest neighbor (k-NN) clustering, hierarchical agglomerative clustering, k-means clustering, and adaptive sample set construction clustering. The representative face image may be determined statistically. For example, the face images in each group may be ordered in accordance with a selected context criterion (e.g., a selected demographic attribute, an image quality score, or a confidence score), and the representative media object may correspond to the centroid or some other statistically-weighted average of the ordered face images. In some examples, the data analysis stage 64 also derives from the sensor data a video segment that is representative of customer visitations to a particular one of the sites over time.

The data visualization stage 66 (FIG. 3) may generate a variety of different graphic visualizations of one or more of the determined visitation patterns. These visitation pattern visualizations enable companies to better manage a variety of different processes that are involved in running a commercial facility, including running marketing campaigns in relation to individual ones of the sites, optimizing a new or existing site in relation to neighboring sites, managing traffic flow through the commercial facility, and scheduling staffing for respective ones of the sites.

In one example, the data visualization stage 66 generates a graphic visualization of customer visitation frequency at a particular one of the sites across different age groups. In another example, the data visualization stage 66 generates a graphic visualization of visitation patterns of the customers to respective ones of the sites neighboring a target location in the commercial facility. The data visualization stage 66 also may generate a graphic visualization of different demographic groups of the customers who have visited a particular one of the sites. For example, the data visualization stage 66 may generate a graphic visualization that includes a respective image of a representative customer for each of one or more the demographic groups being visualized. In these examples, the data visualization stage 66 may determine respective population sizes of the different demographic groups and, in the graphic visualization of different demographic groups, the images of the representative customers have respective sizes that indicate the relative population sizes of the respective demographic groups. Based on one or more commands received in connection with a selected one of the images, the data visualization stage 66 may produce a graphic visualization of a demographic distribution of the customers in the demographic group represented by the selected image. In some examples, the graphic visualization of different demographic groups shows a distribution of different age groups of the customers who have visited the particular site. In other examples, the graphic visualization of different demographic groups shows a distribution of different ethnic groups of the customers who have visited the particular site.

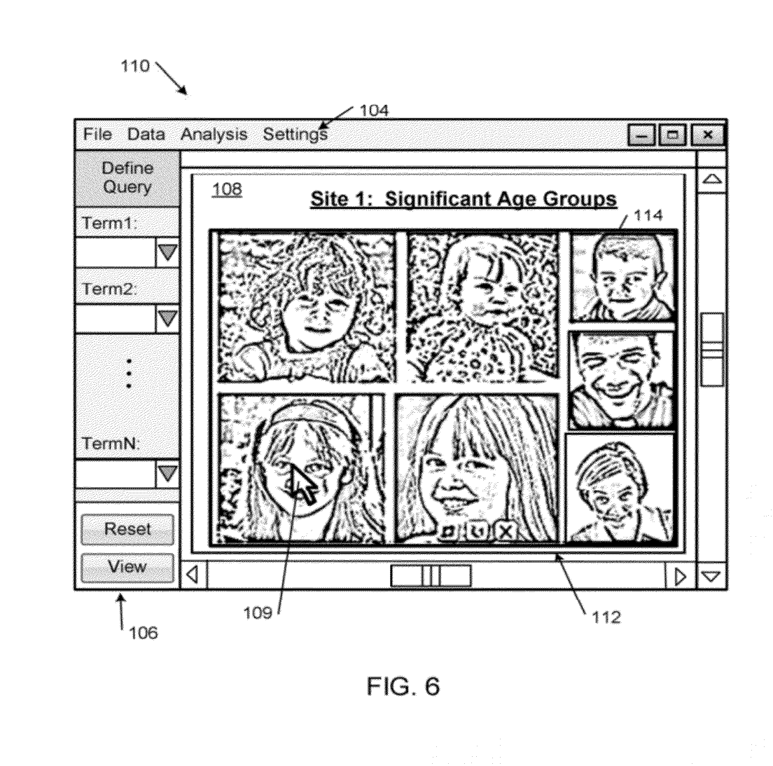

FIG. 6 shows an example of a graphical user interface 110 presenting an example of a graphic visualization 112 of a visitation pattern of a demographic group of customers to a selected site of a commercial facility. The graphical user interface 110 includes a menus area 104, a query definition area 106, and a visualization area 108. The menus 104 provide access to file tools, data tools, analysis tools, and settings tools. The query definition area 106 enables a user to define a query by selecting one or more terms (Term1, . . . TermN) corresponding to different statistics on one or more respective demographic dimensions (e.g., age, gender, relationship). The visualization area 108 contains a visualization of the customer visitation pattern corresponding to the defined query that is produced by the data visualization stage 66. The user may interact with the graphical user interface 110 by inputting commands through an input device (e.g., a computer mouse) in connection with a pointer 109 that is displayed on the graphical user interface 110.

In this example, the visualization 112 shows the distribution of significant (e.g., most populous) age groups of the customers visiting a particular one of the sites 14-28 (i.e., Site 1) over a selected period. Each age group is represented by a respective representative image 114 and the relative sizes of the representative images indicate the relative numbers of customers in the corresponding age groups. In this example, the ratio of the population sizes of the child group and the adult groups provide an indication of the likelihood that the selected site is an attractive destination for families. For example, if the population ratio of children to adult is high, the selected site is more likely to be a popular destination for families, whereas if that ratio is low, the selected site is less likely to be a popular destination for families.

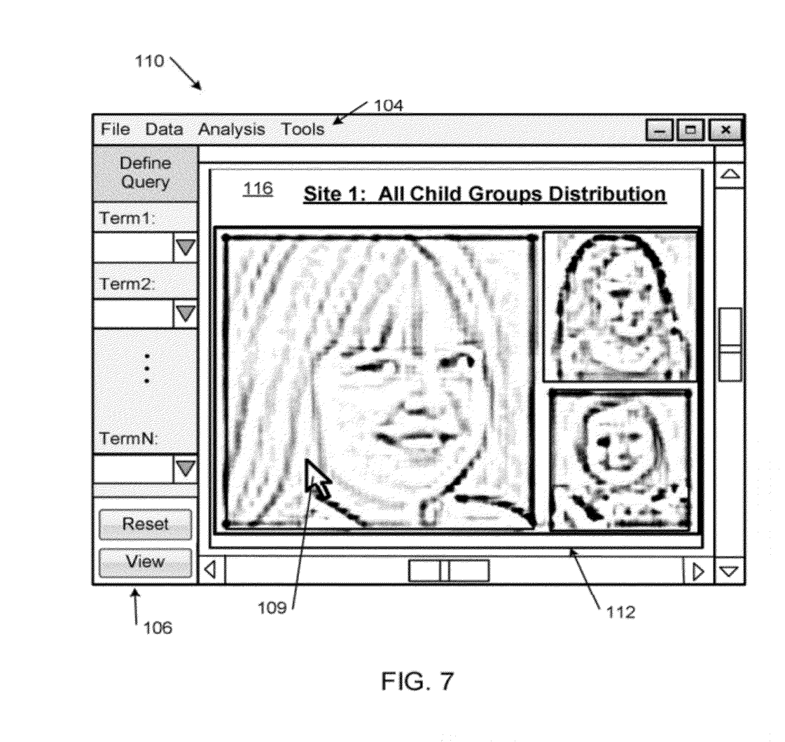

In the example shown in FIG. 6, a user may input a command in connection with any one of the representative images 114 (e.g., by right clicking with a computer mouse or other input device) to activate a context menu allows the user to select a visualization of another distribution of the customers along the age group dimension (e.g., a distribution of all age groups, a distribution of all child groups, and a distribution of all adult groups). For example, FIG. 7 shows an example of the graphical user interface 110 presenting an example of a graphic visualization 116 of the distribution of customers in all child groups visiting the particular site (i.e., Site 1) over the selected period.

In some examples, the data visualization stage 66 (FIG. 3) additionally presents in the visualization area a video segment that is representative of customer visitations to a particular one of the sites over time. In one example, in response to user selection of the graphic visualization 116 of the distribution of customers in all child groups visiting Site 1, the data visualization stage 66 derives a video that is representative of the typical customer traffic visiting Site 1 from the sensor data, and presents the video in the visualization area 108 of the graphical user interface 110. In another example, in response to user selection of the graphic visualization 116 of the distribution of customers in all child groups visiting Site 1, the data visualization stage 66 presents a video (e.g., a direct video feed from one of the sensors associated with Site 1) that shows the current realtime customer traffic visiting Site 1.

Examples of the data processing system 10 may be implemented by one or more discrete modules (or data processing components) that are not limited to any particular hardware, or machine readable instructions (e.g., firmware or software) configuration. In the illustrated examples, these, modules may be implemented in any computing or data processing environment, including in digital electronic circuitry (e.g., an application-specific integrated circuit, such as a digital signal processor (DSP)) or in computer hardware, device driver, or machine readable instructions (including firmware or software). In some examples, the functionalities of the modules are combined into a single data processing component. In some examples, the respective functionalities of each of one or more of the modules are performed by a respective set of multiple data processing components.

The modules of the data processing system 10 may be co-located on a single apparatus or they may be distributed across multiple apparatus; if distributed across multiple apparatus, these modules may communicate with each other over local wired or wireless connections, or they may communicate over global network connections (e.g., communications over the Internet).

In some implementations, process instructions (e.g., machine-readable code, such as computer software) for implementing the methods that are executed by the examples of the data processing system 10, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, examples of the data processing system 10 may be implemented in any one of a wide variety of electronic devices, including desktop computers, workstation computers, and server computers.

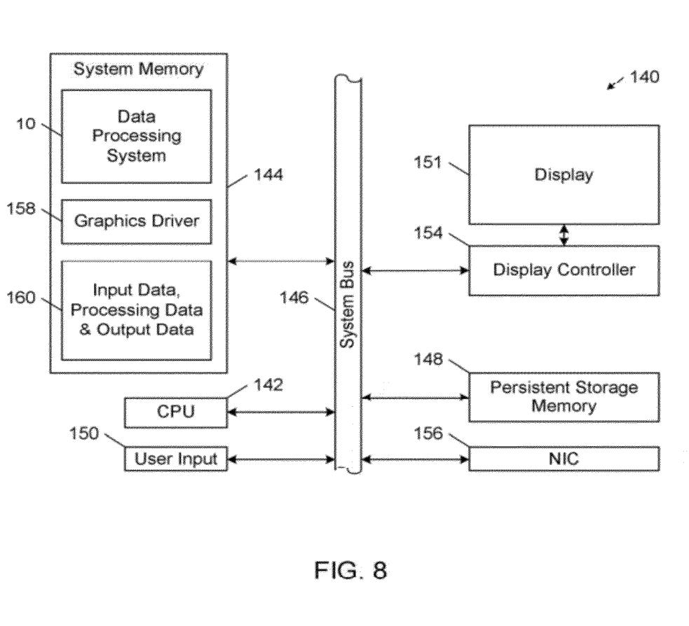

FIG. 8 shows an example of a computer system 140 that can implement any of the examples of the data processing system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 8, the system memory 144 also stores the data processing system 10, a graphics driver 158, and processing information 160 that includes input data, processing data, and output data. In some examples, the data processing system 10 interfaces with the graphics driver 158 to present a user interface on the display 151 for managing and controlling the operation of the data processing system 10.

Other embodiments are within the scope of the claims.

1. A method, comprising:
obtaining sensor data characterizing detected physical presence characteristics of customers visiting respective sites distributed about a commercial facility;
determining visitation patterns of different demographic groups of the customers to the sites; and
generating a graphic visualization of one or more of the visitation patterns;
wherein the obtaining, the determining, and the generating are performed by a computer system.

2. The method of claim 1, wherein the obtaining comprises obtaining images of the customers, and the determining comprises detecting persons in the images and ascertaining respective demographic attributes of the detected persons.

3. The method of claim 2, wherein the determining comprises generating a respective visitation record for each of multiple of the detected persons, wherein each visitation record comprises at least one demographic attribute ascertained for the respective detected person, an identification of a corresponding one of the sites associated with the image in which the person was detected, and a visitation time of the detected person at the corresponding site.

4. The method of claim 1, wherein the generating comprises generating a graphic visualization of customer visitation frequency at a particular one of the sites across different age groups.

5. The method of claim 1, wherein the generating comprises generating a graphic visualization of visitation patterns of the customers to respective ones of the sites neighboring a target location in the commercial facility.

6. The method of claim 1, wherein the generating comprises generating a graphic visualization of different demographic groups of the customers who have visited a particular one of the sites.

7. The method of claim 6, further comprises extracting from the sensor data a respective image of a representative customer for each of the demographic groups being visualized, wherein the graphic visualization of different demographic groups comprises the images of the representative customers.

8. The method of claim 7, wherein the determining comprises determining respective population sizes of the different demographic groups and, in the graphic visualization of different demographic groups; the images of the representative customers have respective sizes indicative of relative population sizes of the respective demographic groups.

9. The method of claim 7, further comprising
based on one or more commands received in connection with a selected one of the images, producing a graphic visualization of a demographic distribution of the customers in the demographic group represented by the selected image.

10. The method of claim 6, wherein the graphic visualization of different demographic groups shows a distribution of different age groups of the customers who have visited the particular site.

11. The method of claim 6, wherein the graphic visualization of different demographic groups shows a distribution of different ethnic groups of the customers who have visited the particular site.

12. The method of claim 1, wherein the determining comprises determining relationships between respective ones of the customers concurrently vising a particular one of the sites, and assigning ones of the customers into respective relationship type demographic groups based on the determined relationships.

13. The method of claim 12, wherein the determining comprises:
determining a respective age category for each of multiple of the customers concurrently visiting a particular one of the sites; and
designating two or more of the customers concurrently visiting the site as members of a respective relationship unit based on the respective age categories determined for the customers.

14. The method of claim 12, wherein the determining comprises:
for each of multiple of the customers concurrently visiting a particular one of the sites, determining a respective age category and a respective gender category; and
designating two or more of the customers concurrently visiting the site as members of a respective relationship unit based on the determined age categories and the determined gender categories.

15. The method of claim 1, further comprising deriving from the sensor data a video segment representative of customer visitations to a particular one of the sites over time, wherein the generating comprises providing the representative video segment in the graphic visualization.

16. The method of claim 1, wherein the commercial facility is an amusement park and each of the sites is a respective point of attraction in the amusement park.

17. The method of claim 1, wherein the commercial facility is a shopping mall and each of the sites is a respective store in the shopping mall.

18. Apparatus, comprising:
a memory storing processor-readable instructions; and
a processor coupled to the memory, operable to execute the instructions, and based at least in part on the execution of the instructions operable to perform operations comprising
obtaining sensor data characterizing detected physical presence characteristics of customers visiting respective sites distributed about a commercial facility;
determining visitation patterns of different demographic groups of the customers to the sites; and
generating a graphic visualization of one or more of the visitation patterns.

19. The apparatus of claim 18, wherein in the generating the processor is operable to perform operations comprising generating a graphic visualization of customer visitation frequency at a particular one of the sites across different age groups.

20. At least one computer-readable medium having processor-readable program code embodied therein, the processor-readable program code adapted to be executed by a processor to implement a method comprising:
obtaining sensor data characterizing detected physical presence characteristics of customers visiting respective sites distributed about a commercial facility;
determining visitation patterns of different demographic groups of the customers to the sites; and
generating a graphic visualization of one or more of the visitation patterns.
